(19) United States
(12) Patent Application Publication
(10) Pub. No.: US 2009/0225051 A1
(43) Pub. Date: Sep. 10, 2009

(54) TOUCH PANEL

(75) Inventor: Chien-Chung Kuo, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/396,488

(22) Filed: Mar. 3, 2009

(30) Foreign Application Priority Data
Mar. 4, 2008 (CN) 200810083181.3

(51) Int. Cl. G06F 3/041

(52) U.S. Cl. 345/173

(57) ABSTRACT

A touch panel having a first conductive layer, a second conductive layer, a plurality of first electrode patterns, and a plurality of second electrode patterns is provided. The first electrode patterns surround the first conductive layer and are electrically connected to the first conductive layer. The second electrode patterns surround the second conductive layer and are electrically connected to the second conductive layer. The first electrode patterns are independent to each other, and the second electrode patterns are independent to each other. The touch panel can be operated in surface capacitive touch sensing mode or a 5-wire resistive touch sensing mode according to the actual requirement. Thereby, the lifespan of the touch panel is prolonged and the reliability thereof is improved.

### CROSS-REFERENCE TO RELATED APPLICATION

This application claims the priority benefit of P.R.C. patent application serial no. 200810083181.3, filed on Mar. 4, 2008. The entirety of the above-mentioned patent application is hereby incorporated by reference herein and made a part of specification.

### BACKGROUND OF THE INVENTION

1. Field of the Invention

The present invention generally relates to a touch panel, in particular, to a touch panel capable of being operated in multiple touch sensing modes.

2. Description of Related Art

Generally, touch panels can be categorized into resistive touch panels and capacitive touch panels according to the structures and driving methods thereof. Regarding a resistive touch panel, a user has to directly press the resistive touch panel so that a part of an upper conductive layer inside the resistive touch panel can be bent and electrically connected with a lower conductive layer to generate a corresponding signal. Thus, the user may operate a touch panel with various media, such as a fingertip or a plastic pen etc. However, the upper conductive layer is always being pressed and bent so that it is easily cracked and may result in touch sensing failure.

Regarding a capacitive touch panel, a capacitance change is generated when a user touches the capacitive touch panel, and the capacitive touch panel implements the touch sensing through the capacitance change. Thus, the capacitive touch panel can sense a user's touch without actually pressing the capacitive touch panel, so that the damages of the capacitive touch panel due to being pressed over and over would be restrained. However, a capacitive touch panel cannot be operated with a gloved finger or an insulative medium. Besides, the capacitive touch panel may sense incorrectly if a water drop or a conductive particle falls on the capacitive touch panel.

### SUMMARY OF THE INVENTION

Accordingly, the present invention is directed to a touch panel, wherein the touch panel integrates both of a resistive touch sensing design and a capacitive touch sensing design such that the aforementioned disadvantages can be overcome.

One embodiment of present invention provides a touch panel having a first substrate, a second substrate opposite to the first substrate, a first conductive layer, a second conductive layer, first electrode patterns, second electrode patterns, spacers, first conductive wires and second conductive wires. The first electrode patterns are formed on the first conductive layer and arranged near the periphery of the first conductive layer. The first electrode patterns are electrically connected to the first conductive layer. The second electrode patterns are formed on the second conductive layer and arranged near the periphery of the second conductive layer. The second electrode patterns are electrically connected to the second conductive layer. The touch panel further includes a plurality of first conductive wires and a plurality of second conductive wires. The first conductive wires electrically connect to the first electrode patterns and the second conductive wires electrically connect to the second electrode patterns. The first conductive wires may be located at the corners or the sides of the first conductive layer when the first conductive layer is in a rectangular shape. The second conductive wires may be located at the corners of the second conductive layer when the second conductive layer is in a rectangular shape. The touch panel can be selectively operated in a surface capacitive touch sensing mode or in a 5-wire resistive touch sensing mode by a driving circuit (not shown).

According to an embodiment of the present invention, the first electrode patterns are independent to each other and arranged near the periphery of the first conductive layer all together. Substantially, the first electrode patterns include at least a straight line segment and at least a crooked line segment.

According to an embodiment of the present invention, the second electrode patterns are independent to each other and arranged near the periphery of the second conductive layer all together. Substantially, the second electrode patterns include at least a straight line segment and at least a crooked line segment.

According to an embodiment of the present invention, a material of the first conductive layer and the second conductive layer comprises a transparent conductive material, for example, indium tin oxide (ITO) or indium zinc oxide (IZO).

In a touch panel provided by the embodiments of the present invention, a plurality of electrode patterns is respectively disposed at the edges of a first conductive layer and a second conductive layer, and these electrode patterns are independent to each other. Specific electric fields can be formed in the first conductive layer and the second conductive layer respectively through these electrode patterns. Thus, the touch panel in the present invention can be operated in at least a surface capacitive touch sensing mode and a 5-wire resistive touch sensing mode. Foregoing two touch sensing modes can be switched and accordingly the disadvantages thereof can be compensated for. Thereby, a touch panel in the present invention will not mis-sense a conductive particle dropped thereon or be damaged in the conductive layer by a frequently bent.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are respectively an explosion diagram and a cross-sectional view of a touch panel according to an embodiment of the present invention.

FIG. 2A and FIG. 2B are diagrams respectively illustrating an equivalent circuit diagram of the touch panel being operated in a surface capacitive touch sensing mode according to an embodiment of the present invention.

FIG. 3A and FIG. 3B are diagrams illustrating a touch panel being operated in a resistive touch sensing mode according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The characteristics and functions of a touch panel provided by the present invention will be described below with reference to embodiments of the present invention and accompanying drawings.

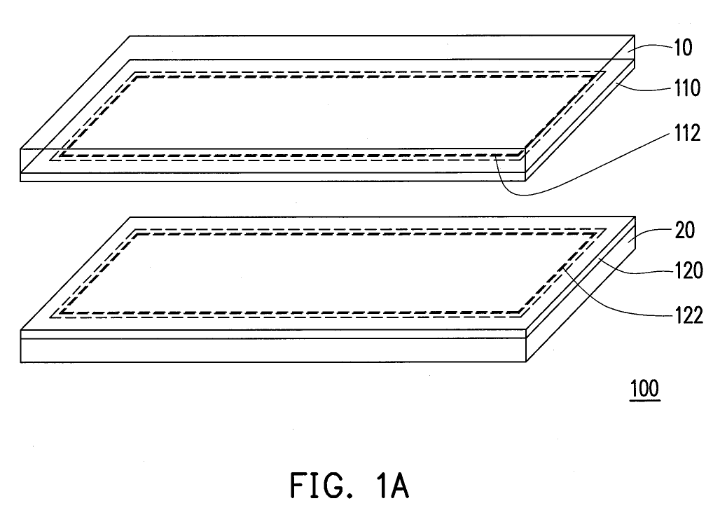

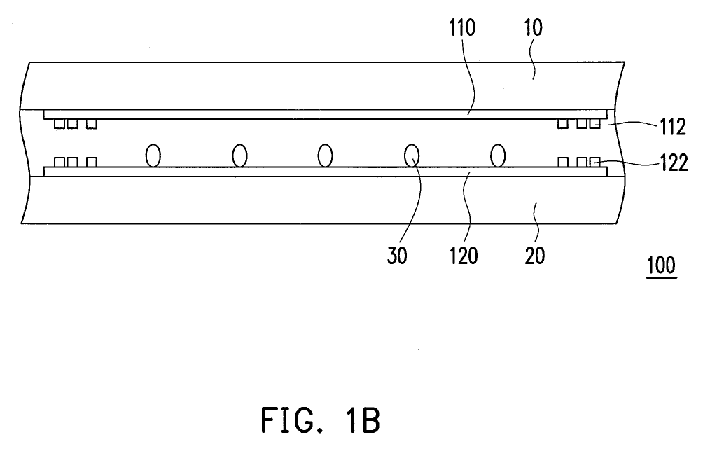

FIG. 1A and FIG. 1B are respectively an explosion diagram and a cross-sectional view of a touch panel according to an embodiment of the present invention. Referring to FIG. 1A and FIG. 1B, the touch panel 100 has a first substrate 10, a second substrate 20, a first conductive layer 110 formed on the first substrate 10, a second conductive layer 120 formed on the second substrate 20, a plurality of first electrode patterns 112, and a plurality of second electrode patterns 122. In the present embodiment, the first conductive layer 110 and the second conductive layer 120 may respectively be in a rectangular shape. The first electrode patterns 112 are formed on the first conductive layer 110 and approximately arranged near the periphery of the first conductive layer 110. The second electrode patterns 122 are formed on the second conductive layer 110 and approximately arranged near the periphery of the second conductive layer 120. Namely, the first electrode patterns 112 and the second electrode patterns 122 respectively form a rectangular frame approximately. It should be mentioned that in the present embodiment, each of the first electrode patterns 112 and each of the second electrode patterns 122 are independent to each other.

The first conductive layer 110, the second conductive layer 120, the first electrode patterns 112, and the second electrode patterns 122 are fabricated through related semiconductor processes such as thin film deposition. The touch panel 100 is usually attached to a display panel so as to provide a convenient operation thereof. To further improve the optical characteristics of the touch panel 100, the first conductive layer 110 and the second conductive layer 120 may be fabricated with a transparent conductive material, such as indium tin oxide (ITO), indium zinc oxide (IZO), or other suitable materials. While fabricating the first conductive layer 110 and the second conductive layer 120, the process conditions can be adjusted appropriately to allow the first conductive layer 110 and the second conductive layer 120 to have certain resistances so that the touch panel 100 can work properly. In short, the first conductive layer 110 and the second conductive layer 120 are electrically conductive, but the conductivity of the first conductive layer 110 and the second conductive layer 120 is worse than that of the first electrode patterns 112 and the second electrode patterns 122. In addition, a plurality of spacers 30 is disposed between the first substrate 10 and the second substrate 20 so as to separate the first conductive layer 110 from the second conductive layer 120.

In the present embodiment, the first electrode patterns 112 are independent to each other, and each of the first electrode patterns 112 may be a straight line segment or a crooked line segment. The dash line segments shown in FIG. 1A are only illustrated schematically. Actually, the first electrode patterns 112 may be in many different shapes, such as Z shape, I shape, L shape, and staircase shape etc. Besides, the first electrode patterns 112 may be arranged in multiple rows and the first electrode patterns 112 in the rows may be staggered arranged. In other words, the first electrode patterns 112 which surround the first conductive layer 110 may completely enclose a part of the first conductive layer 110. In addition, the second electrode patterns 122 may also be straight line segments or crooked line segments which are independent to each other. In the present embodiment, the first electrode patterns 112 and the second electrode patterns 122 may be disposed in the same way but may have the same or different shapes. As well, the second electrode patterns 122 which surround the second conductive layer 120 may also be arranged into multiple rows and the second electrode patterns 122 in each row may also be arranged in a staggered way so as to completely enclose a part of the second conductive layer 120. The present invention is not restricted to the abovementioned, and the electrode patterns (112 and 122) can be disposed in any way such that an even electric field can be generated in the first conductive layer 110 and the second conductive layer 120 respectively.

Under the condition that the first electrode patterns 112 and the second electrode patterns 122 are all independent to each other and respectively located near the periphery of the first conductive layers 110 and the second conductive layer 120, the touch panel 100 can be operated in at least two touch sensing modes. These two touch sensing modes may include a surface capacitive touch sensing mode and a 5-wire resistive touch sensing mode, and which will be described below with examples. However, the present invention is not limited to foregoing two modes, and any other touch sensing mode which can be applied to foregoing design of electrode patterns can be applied to the touch panel 100.

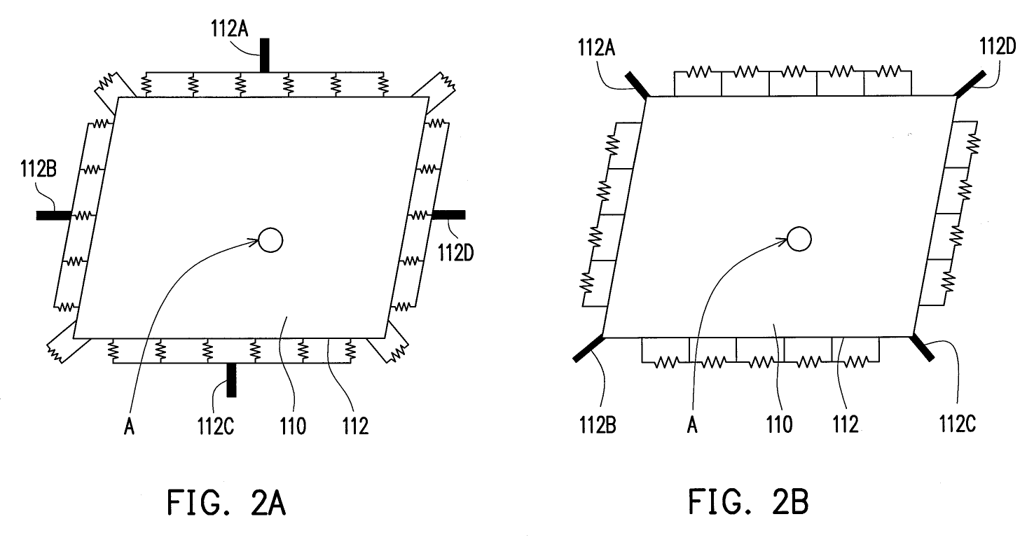

FIG. 2A and FIG. 2B are diagrams respectively illustrating an equivalent circuit diagram of the touch panel being operated in the surface capacitive touch sensing mode according to an embodiment of the present invention, wherein only some elements, such as the first conductive layer, are illustrated. Referring to both FIG. 1A and FIG. 2A, the touch panel 100 further includes a plurality of first conductive wires 112A˜112D. The first conductive wires 112A˜112D are disposed at the sides of the first conductive layer 110 and are electrically connected to the first electrode patterns 112. In the present embodiment, when the touch panel 100 is operated in the surface capacitive touch sensing mode, a voltage, such as alternating current voltage, is supplied from the first conductive wires 112A˜112D to the first electrode patterns 112 by using a controller chip (not shown) of the touch panel 100. The wiring layout between the first electrode patterns 112 helps to form a uniform electric field in the first conductive layer 110. When a user touches the position A with a finger or other conductive object, the uniform electric field is disturbed and accordingly a specific current is generated. Herein, a specific relationship between the distance between the position A and the first conductive wires 112A˜112D and the specific current is presented. Accordingly, the controller chip can calculate the position touched by the user according to the current received by the first conductive wires 112A˜112D.

In addition, the first conductive wires 112A˜112D may also be located elsewhere than at the sides of the first conductive layer 110. Referring to FIG. 1A and FIG. 2B, the first conductive wires 112A˜112D may be located at the corners of the first conductive layer 110 and electrically connected to the first electrode patterns 112. Similarly, when a voltage is supplied to the first conductive wires 112A˜112D, a uniform electric field is produced by the first electrode patterns 112 in the first conductive layer 110. When the user touches the position A with a conductive object, a specific relationship is presented between the current received by the first conductive wires 112A˜112D and the distance between the position A and the first conductive wires 112A˜112D. Thereby, the touch panel can be operated in the surface capacitive touch sensing mode even when the first conductive wires 112A˜112D are disposed at the corners of the first conductive layer 110.

Actually, a convenient operation interface can be provided by integrating the touch panel 100 with a display panel (not shown). If the first conductive layer 110 is closer to the user after the display panel is attached to the touch panel 100, the first conductive layer 110 can be used for performing surface capacitive touch sensing. Here the second electrode patterns 122 may be connected to a ground voltage in order to prevent the signals of the touch panel 100 and the display panel from disturbing each other, namely, the second conductive layer 120 is used as a shield conductive layer when the touch panel is selectively operated in a surface capacitive touch sensing mode. Specifically, which conductive layer (the conductive layer 110 or the conductive layer 120) is used for performing surface capacitive touch sensing is not limited in the present invention.

However, just like the conventional capacitive touch panel, the touch panel 100 may sense an incorrect signal when water or a conductive particle drops on the touch panel 100 when it is operated in the surface capacitive touch sensing mode. To avoid such incorrect sensing, the touch panel 100 in the present invention can also work in another touch sensing mode, namely, the 5-wire resistive touch sensing mode.

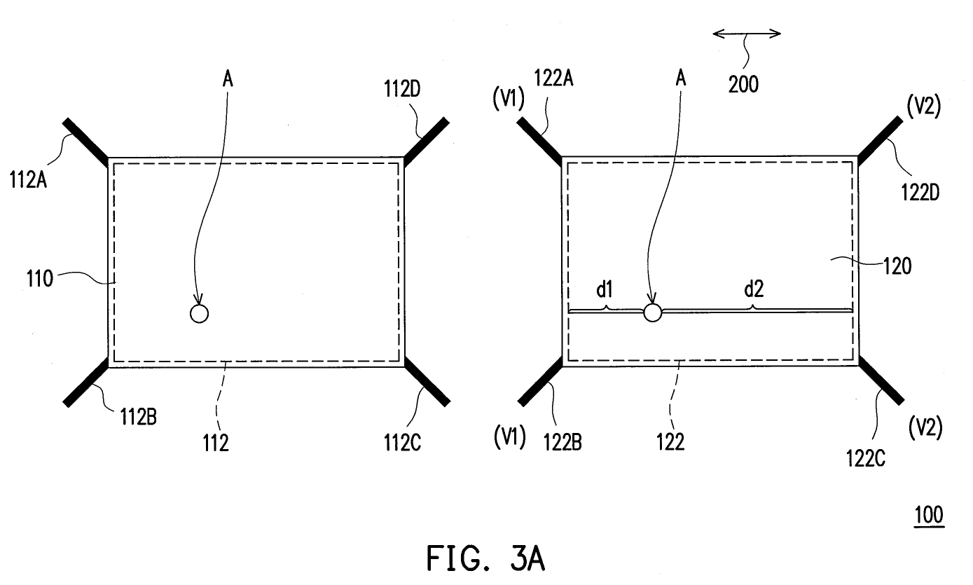

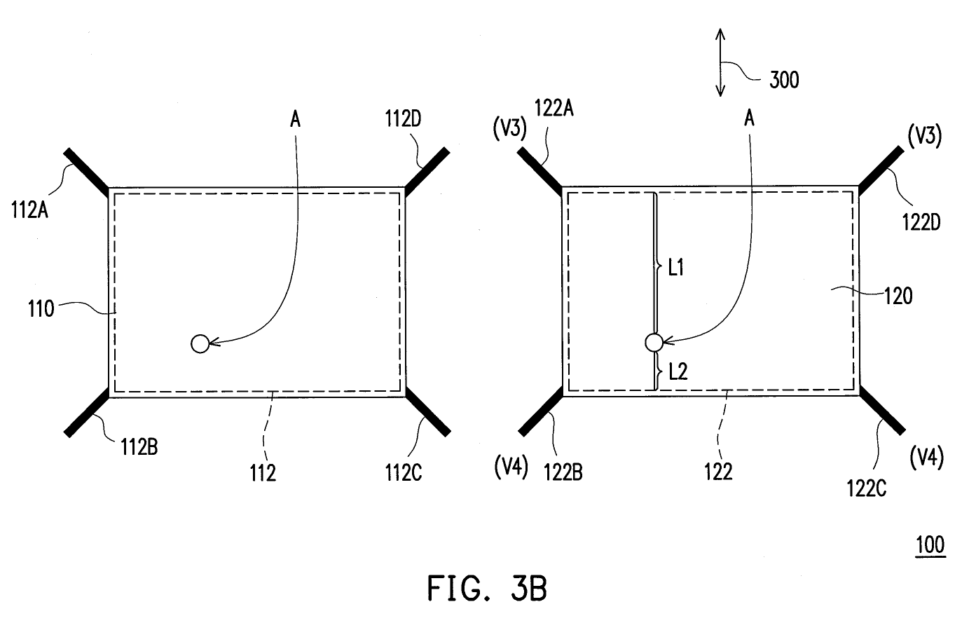

FIG. 3A and FIG. 3B are diagrams illustrating a touch panel being operated in a 5-wire resistive touch sensing mode according to an embodiment of the present invention. Referring to FIG. 3A, the touch panel 100 further includes a plurality of first conductive wires 112A˜112D and a plurality of second conductive wires 122A˜122D. The first conductive wires 112A˜112D may be located at the corners or the sides of the first conductive layer 110. Herein the first conductive wires 112A˜112D being located at the corners of the first conductive layer 110 will be taken as an example. The second conductive wires 122A˜122D are, for example, located at the corners of the second conductive layer 120. Besides, the first conductive wires 112A˜112D are electrically connected to the first electrode patterns 112, and the second conductive wires 122A˜122D are electrically connected to the second electrode patterns 122. The 5-wire resistive touch sensing performed by the touch panel 100 when a user touches the touch panel 100 can be divided into two phases approximately. During the first phase, a voltage V1 is supplied to the second conductive wires 122A and 122B, and another voltage V2 is supplied to the second conductive wires 122C and 122D, wherein the voltage V1 is different from the voltage V2, and under the voltages V1 and V2, an electric field in the second conductive layer 120 is produced along the direction of the arrow 200 by the disposition of the second electrode patterns 122. Under the affection of this electric field, different voltages are presented at different positions in the second conductive layer 120 along the direction of the arrow 200.

For example, if the voltage V1 is different from the voltage V2, the second electrode patterns 122 produce a uniform electric field in the second conductive layer 120, and the voltage V_{A} at the position A is related to the distances d1 and d2. Thus, if the first conductive layer 110 and the second conductive layer 120 are connected at the position A because of the pressing of a user, one of the first conductive wires 112A˜112D of the touch panel 100 detects the voltage value V_{A} and accordingly the coordinates of the positions A touched by the user along the direction of the arrow 200 can be calculated in a driving chip (not shown).

Referring to FIG. 3B, during the second phase, a voltage V3 is supplied to the second conductive wires 122A and 122D, and a voltage V4 is supplied to the second conductive wires 122B and 122C, wherein the voltage V3 is different from the voltage V4. Substantially, the voltage V3 may be equal to the voltage V1, and the voltage V4 may be equal to the voltage V2, or the voltage V3 may be equal to the voltage V2, and the voltage V4 may be equal to the voltage V1. Thus, an electric field along the direction of the arrow 300 is produced in the first conductive layer 110, and the voltage value V_{A} at the position A is related to the distances L1 and L2. Here if the position A is touched and accordingly the first conductive layer 110 and the second conductive layer 120 are contacted, one of the first conductive wires 112A˜112D detects the voltage value V_{A} and accordingly the coordinates of the position A touched by the user along the direction of the arrow 300 can be obtained. After foregoing two phases are completed, the location of the position A touched by the user can be accurately positioned, and the instruction input by the user can then be carried out. In other words, when the touch panel 100 is operated in the 5-wire resistive touch sensing mode, the voltages supplied to the second conductive wires 122A˜122D have to be switched so that electric fields in different directions can be produced and accordingly the position touched by the user can be accurately sensed.

As described above, in the present embodiment, the second conductive layer 120 is used as a signal input layer and the first conductive layer 110 is used as a signal sensing layer. However, the present invention is not limited thereto, and the first conductive layer 110 may also be used as the signal input layer, and the second conductive layer 120 may also be used as the signal sensing layer. In other words, the voltages supplied to the second conductive wires 122A˜122D may also be supplied to the first conductive wires 112A˜112D, and one of the second conductive wires 122A˜122D may be used for touch sensing. Since the first conductive wires 112A˜112D and the second conductive wires 122A˜122D are respectively located at the corners of the conductive layers 110 and 120, the power lines caused by the first conductive wires 112A˜112D and the second conductive wires 122A˜122D enclose the entire conductive layers 110 and 120. Hence, any position in the first conductive layer 110 and the second conductive layer 120 touched can be sensed. However, the present invention is not limited to foregoing example, and in another embodiment of the present invention, the conductive wires may also be disposed at the sides of the conductive layer which is used as the signal sensing layer with affecting the functions of the touch panel 100.

Generally speaking, when the touch panel 100 is operated in the 5-wire resistive touch sensing mode, the touch panel 100 will not sense incorrectly even when there is water or conductive particle drops thereon. In other words, if there is conductive particle falling on the touch panel 100, the touch panel 100 can be switched to the 5-wire resistive touch sensing mode so that incorrect touch sensing can be avoided. In addition, the signal sensing layer is used only for sensing, so that any defect or small crack thereon will not affect the value or state of the sensed signal. Namely, the touch sensing function of the touch panel 100 is not affected even when the conductive layer in the touch panel 100 which is served as the signal sensing layer has some small cracks. Thereby, the touch panel 100 provided by the present invention has longer lifespan.

Since the touch panel 100 can be operated in the surface capacitive touch sensing mode or the 5-wire resistive touch sensing mode, a user can use a conductive object or a non-conductive object to operate the touch panel 100. If the user uses a finger to operate the touch panel, the touch panel 100 works in the surface capacitive touch sensing mode, and if the user uses a gloved finger or a plastic pen to operate the touch panel, the touch panel 100 can then be switched to being operated in the 5-wire resistive touch sensing mode. If the user uses a finger to operate the touch panel 100, the touch panel 100 may also be switched to the 5-wire resistive touch sensing mode so as to avoid incorrect sensing caused by conductive object contamination. Actually, the timing for switching the touch sensing mode of the touch panel 100 is not restricted in the present invention, and the touch sensing mode of the touch panel 100 can be selected and switched according to different application environments or the habit of different users.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a first substrate and a second substrate opposite to the first substrate;
a first conductive layer formed on the first substrate;
a second conductive layer formed on the second substrate;
a plurality of first electrode patterns formed on the first conductive layer and arranged near the periphery of the first conductive layer;
a plurality of second electrode patterns formed on the second conductive layer and arranged near the periphery of the second conductive layer;
a plurality of spacers provided between the first electrode patterns and the second electrode patterns;
a plurality of first conductive wires electrically connected to the first electrode patterns; and
a plurality of second conductive wires electrically connected to the second electrode patterns;
wherein the touch panel is selectively operated in a surface capacitive touch sensing mode and in a 5-wire resistive touch sensing mode.

2. The touch panel according to claim 1, wherein the first conductive layer is in a rectangular shape, and the first conductive wires are located at the corners or sides of the first conductive layer.

3. The touch panel according to claim 1, wherein the first electrode patterns are independent to each other and substantially arranged near the periphery of the first conductive layer all together.

4. The touch panel according to claim 3, wherein each of the first electrode patterns is a straight line segment or a crooked line segment.

5. The touch panel according to claim 1, wherein the second conductive layer is in a rectangular shape, and the second conductive wires are located at the corners of the second conductive layer.

6. The touch panel according to claim 1, wherein the second electrode patterns are independent to each other and substantially arranged near the periphery of the second conductive layer all together.

7. The touch panel according to claim 6, wherein each of the second electrode patterns is a straight line segment or a crooked line segment.

8. The touch panel according to claim 1, wherein a material of the first conductive layer and the second conductive layer comprises respectively a transparent conductive material.

9. The touch panel according to claim 8, wherein the transparent conductive material is indium tin oxide (ITO) or indium zinc oxide (IZO).
